(19) United States
(12) Patent Application Publication
(10) Pub. No.: US 2004/0177133 A1
(43) Pub. Date: Sep. 9, 2004

(54) Intelligent configuration bridge system and method for adding supplemental capabilities to an existing high speed data infrastructure

(75) Inventors: Bruce S. Harrison, Fairfax Station, VA (US); Xiaohui He, Reston, VA (US); Martin R. Hannes, Washington, DC (US)

Correspondence Address: SUGHRUE MION, PLLC, 2100 PENNSYLVANIA AVENUE, N.W., SUITE 800, WASHINGTON, DC, 20037, US

(73) Assignee: Next Generation Broadband

(21) Appl. No.: 10/704,648

(22) Filed: Nov. 12, 2003

Related U.S. Application Data
(60) Provisional application No. 60/425,507, filed on Nov. 12, 2002.

(51) Int. Cl. G06F 15/177

(52) U.S. Cl. 709/220; 709/230

(57) ABSTRACT

A computer readable medium, configuration server, and configuration system for receiving and processing a subscriber node address request is provided. A bridge service module provides a predetermined bridging criterion to a bridge extension module, the bridge extension module makes a bridging determination based on the bridging criterion and the subscriber node address request and provides a bridging message based on the subscriber node address request, when a result of the bridging determination indicates that the bridging message is to be provided. The configuration server may be a DHCP server in cable network environment, such that a cable modem receives an IP address and configuration data responsive to the subscriber node address request from a second DHCP server to which the bridging message is transmitted.

### CROSS-REFERENCE TO RELATED APPLICATIONS.

This Application claims the benefit of U.S. Provisional Patent Application No. 60/425,507, filed Nov. 12, 2002, which is incorporated by reference, herein, in its entirety.

### BACKGROUND

1. Field fo the Invention

The present Application relates generally to the field of telecommunications and data networks, and the non-limiting embodiments relate to configuration servers using DHCP.

2. Industry Overview

The Internet as we know it today, was created by the Defense Advanced Research Project Agency (DARPA) of the United States Federal Government's Department of Defense (DOD) as a response to the start of the Cold War. The goal was to create a communications network that was reliable and robust. In 1969, the U.S. government created the Advanced Research Project Agency Network (ARPANET), connecting four western universities and allowing researchers to use the mainframes of any of the networked institutions. New connections were soon added to the network, bringing the number of these “nodes” up to 23 in 1971; 111 in 1977 and up to almost four million in 1994.

In order for the computers to communicate, each computer must have a unique identification number known as Internet Protocol Address (IP Address). The assignment and configuration of the IP Address was accomplished initially as a manual process. This process is also known as a registration process. As internet usage grew over the years, the maintenance of these static addresses became increasingly difficult to manage. Furthermore, the registration and administration process was neither easy nor trivial. A new initiative was started in the early 1990s by the Internet Engineering Task Force (IETF) to define a new method for dealing with the administrative overhead of IP address assignment. In October 1993, the working group assigned to handle this task released a first draft of the proposed solution in Request for Comment draft 1531 (RFC 1531). The solution was a configuration protocol called Dynamic Host Configuration Protocol (DHCP).

DHCP operates under a client-server model. Some terms used are defined as follows:

1. DHCP client. An Internet host using DHCP to obtain configuration parameters such as a network address. This host is sometimes referred to as Customer Premise Equipment (CPE).

2. DHCP server. An Internet host that returns configuration parameters to DHCP clients.

3. BOOTP relay agent. An Internet host or router that passes DHCP messages between DHCP clients and DHCP servers. DHCP is designed to use the same relay agent behavior as specified in the BOOTP protocol specification.

4. Binding. A collection of configuration parameters, including at least an IP address, associated with or “bound to” a DHCP client. Bindings are managed by DHCP servers.

DHCP Process Flow

The DHCP process comprises four steps between the requesting client and responding server:

1. DHCP Discover. The client announces its presence on the network, and sends out an IP address search request to all DHCP servers on the given network. This is also known as a “broadcast request.”

2. DHCP Offer. Any server that is able to match the requested criteria will respond back to the requesting client.

3. DHCP Request. The client confirms the offer, after the offer has been received, by sending a confirmation request to the specific server which provided the information. This is also known as a “unicast request.”

4. DHCP Ack. The server acknowledges the acceptance from the client, marks that IP address as assigned, and then responds back to the requesting client to complete the process.

Thus, DHCP allows the network administrator to easily lease IP addresses dynamically to a requesting client.

DHCP was quickly adopted by major Operating Systems (OS) vendors such as Microsoft, Sun, IBM, DEC, HP, as well as hardware vendors such as Cisco, Nortel, Juniper. This industry acceptance gave rise to the quick expansion of the internet; no longer did network administrators have to spend countless hours on the manual process of assigning IP addresses. This configuration protocol brought about the huge surge of internet usage of both residential and corporate users. Instead of assigning static IP addresses, network administrators were now easily able to assign IP addresses to users for a certain amount of time, and reclaim unused addresses for others. The entire process of registration now was done dynamically and automatically. DHCP was adopted by corporate network administrators, as well as, internet service providers (ISPs).

Limitations of Existing DHCP Systems

Since the inception of DHCP, enhancements of this protocol have been focused predominantly on scalability and stability, instead of additional functionality such as security, custom service adoption, or alteration of DHCP processing. Despite a few later revisions of the protocol enhancement (RFC 1532-1534, 1541-1542, 2131-2132, 2241-2242, 2485, 2489, 2563, 2610, 2937, 2939, 3004, 3011, 3046, 2074, 3118, 3203, 3256, 3315, 3396, 3422, 3495, 3527, and 3574, courtesy of IETF working groups [http://www.ietf.org]), no one has been able to explore fully the potential of this protocol nor has any vendor successfully implemented DHCP to include newer features or functionalities to assist service providers or corporate network administrators to manage the rapidly growing methods of internet usage and access.

DHCP remains as it has been, a simple protocol. The IETF and Internet Software Consortium (ISC) have argued to keep DHCP simple, and have left the expansion of protocol capability to users. Unfortunately, to date, the following limitations of DHCP remain:

1. Lack of extensibility. Due to the simplicity of design, none of the vendors who supply DHCP servers are willing to include non-standard functions to enhance the protocol capability.

2. Lack of security control. Any network user is able to obtain an IP address regardless of authorization level.

3. Lack of interoperability with existing infrastructure. Instead of having DHCP adapt to existing infrastructure, the existing infrastructure has to be altered to accommodate the implementation of DHCP.

4. Limited capability for administration control. In a typical DHCP environment the CPE IP addresses are dynamically assigned over brief time periods. Aside from defining the allocation of IP addresses, network administrators have limited control of how the IP address can be assigned.

5. Limited capability to build new features and services. DHCP does not offer a method for easily adjusting to new business models or service delivery.

6. Limited data storage. Despite attempts by a few DHCP vendors to utilize Lightweight Directory Access Protocol (LDAP) and other types of databases as a replacement for internal data store methods, large ISP environments are difficult to scale and subject to performance related failures. Please note, the term LDAP has been used later in this document as a reference to related DHCP databases but could also relate to other types of similar databases as noted above.

7. Limited ability to meet traffic engineering tasks. The internet today is full of worms and Trojans, and the DHCP protocol lacks the capability to integrate effectively with Intrusion Detection Systems (IDS), Intrusion Prevention Systems (IPS) and Application Policy Servers to segregate virus-infected or hacker-type client stations that are harmful to the entire network.

Alternative Technologies

Various approaches to overcome these limitations of DHCP have been proposed, but most have technical limitations or introduce operational inefficiencies.

When an end device, such as a CPE or its associated terminal equipment, is initially assigned an IP address or renews an IP address, a decision must be made regarding which IP address and IP configuration to provide. The alternatives include: manually assigning static IP addresses; using a session management system or utilizing some form of special CPE filtering.

In each case, significant investment in equipment to be installed through the network or significant operator manual involvement in configuring and maintaining the overall network is required.

A static IP address assignment requires an operator to permanently and manually assign addresses, and therefore a key efficiency and benefit of dynamic assignment of IP addresses would be lost. Today, static IP addressing is used only for a small fraction of users on most networks.

Session based computing methods may also be used to a more limited extent to provide various other functions. However, in session based computing, the end device must use industry standard log-in protocols and processes such as RADIUS and PPPOE. In each case, the end device must provide a unique identifier and means of authentication to a centralized server that recognizes the end device and, based on the device's credentials, provides it with an IP address and IP configuration data. For a session based approach to work, the broadband network would have to be configured such that, all CPEs or associated terminal equipment would need to log into the network before the Internet or any network based applications such as email could be accessed. Subsequently, all terminal generated traffic would be routed through a central communication server that would require the user of the terminal to provide credentials such as user name and password to log in. Once logged in, the central server would use IP routing protocol such as proxy routing techniques to direct all traffic to specific and authorized applications.

However, the session based approach requires that significant hardware be installed throughout the network to support the routing function. It also requires that every user have a user name and password and log into the system every time the user accesses the service provider's network. . . This approach increases network costs and administrative costs (i.e. having to provide and maintain tens of millions of user names) and defeats one the benefits of an “always-on” broadband service. As discussed earlier, a broadband service is designed to be an always on system such that any end device may be connected and access the network without having to log into the system or be pre-registered.

Furthermore, the session based approach introduces traffic bottlenecks and points of failure since all traffic needs to flow through centralized communication or proxy servers.

Another technique to manage and route physical CPE involves the deployment of IP filters in the CPE and network routers to control access to limited areas of the network or specific services. An IP filter is a programmable feature within a device that blocks access by the device to specific IP addresses. IP filters can be set in routers, modem termination systems, modems and other remote devices. The filter must be set centrally and the location in the network and IP address must be known for all target devices.

From an application perspective, an IP filter is most commonly used to simply block or permit IP traffic to flow across a particular piece of equipment or network node. Thus, in a filter type architecture, the filter can only block IP traffic based on the source or destination IP address of incoming IP packets.

This approach requires that the CPE and terminal devices be provided routing information. If IP filters are used, every application sits on the same physical network.

Also, filtering requires significant administration and maintenance. With filters, the network administrator must have a complete understanding of the nature of a changing network, such that every time a component is dropped or added to the network, the filters must be updated to accommodate that change. In a large IP network, this can require millions of changes per year.

Moreover, there are several significant security issues with filtering, particularly if all the applications for classes of users are on the one logical network. One mistake in setting the filters can potentially open security holes in the network that could enable users from one class to access systems that they are not authorized to access.

### SUMMARY OF THE INVENTION

Non-limiting aspects of preferred embodiments of the present invention include the following.

A configuration server for receiving and processing a subscriber node address request is contemplated, the configuration server comprising:

a bridge service module and a bridge extension module;

said bridge service module configured to provide a predetermined bridging criterion to said bridge extension module;

said bridge extension module configured to make a bridging determination based on the bridging criterion and the subscriber node address request; and

said bridge extension module further configured to provide a bridging message based on the subscriber node address request, when a result of the bridging determination indicates that the bridging message is to be provided.

The configuration server may be a DHCP server or its equivalent, the subscriber node may be a modem attached to a user terminal, and the address request may be a request for an IP address received via a network. The network may be any configuration based server network, including but not limited to cable, DSL, satellite or wireless networks.

The predetermined criterion could be based on at least one of the following: whether the modem associated with the subscriber node and whether a user associated with the subscriber node is newly established to the network. The predetermined criterion could be based on at least one type of user associated with the subscriber node, a size of a business user entity associated with the subscriber node, a payment method utilized by a user associated with the subscriber node, a pre-paid status associated with the subscriber node, a bandwidth requirement associated with the subscriber node, a bandwidth subscription associated with the subscriber node, a subscription payment record associated with the subscriber node, a usage history associated with the subscriber node, a usage quota associated with the subscriber node, a user behavior associated with the subscriber node, and a network security indication associated with the subscriber node.

A processor-readable medium incorporating a program of instructions to be executed by a configuration server is also described, such that the program is configured to process a subscriber node address request received, the program comprising:

a bridge service module and a bridge extension module;

said bridge service module configured to provide a predetermined bridging criterion to said bridge extension module;

said bridge extension module configured to make a bridging determination based on the predetermined bridging criterion and the subscriber node address request; and

said bridge extension module further configured to provide a bridging message based on the subscriber node address request, when a result of the bridging determination indicates that the bridging message is to be provided.

A configuration system including a configuration server for receiving and processing a subscriber node address request and a bridge configuration server is also provided, such that the configuration server comprises:

a bridge service module and a bridge extension module;

said bridge service module configured to provide a predetermined bridging criterion to said bridge extension module;

said bridge extension module configured to make a bridging determination based on the predetermined bridging criterion and the subscriber node address request; and

said bridge extension module further configured to provide to said bridge configuration server a bridging message based on the subscriber node address request, when a result of the bridging determination indicates that the bridging message is to be provided.

With respect to the configuration system, the configuration server may be a DHCP server, the subscriber node can comprise a modem, including a DSL modem, a wireless modem, a satellite modem and/or a cable modem attached to a user terminal, and the address request may be a request for an IP address received via a network. The network may be any configuration based server network, including but not limited to cable, DSL, satellite or wireless networks.

Further, in an illustrative embodiment of the configuration system, the bridge configuration server is configured to provide at least an IP address and configuration information to the subscriber node based on the bridging message.

### BRIEF DESCRIPTION OF THE DRAWINGS

FIG. 1 is a diagram that shows an overview of the Parallel Systems Technology enabled by the Intelligent Configuration Bridge in a system according to the present invention.

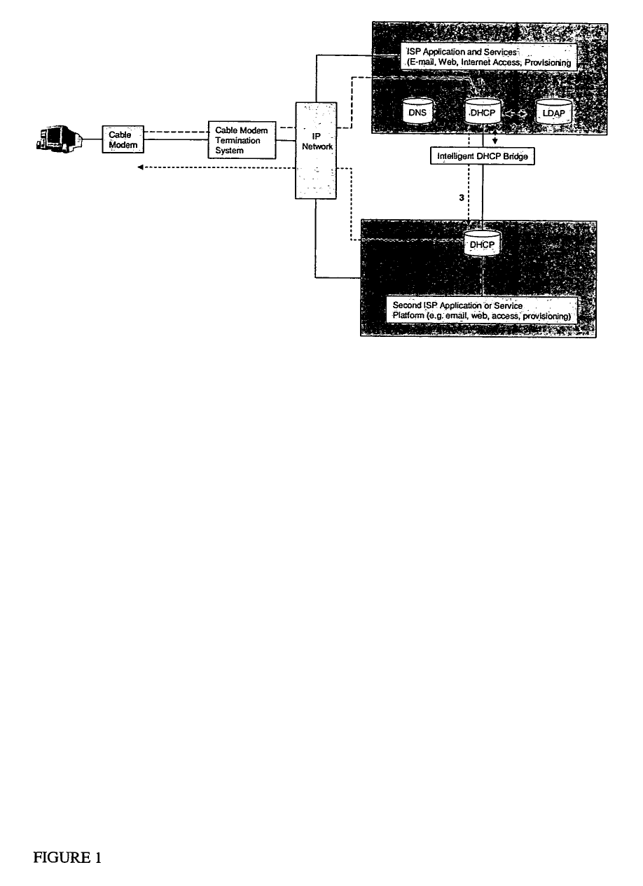

FIG. 2 is a diagram at a high-level of an example of messaging used in the bridging process for a DHCP client request for an IP address and related host configuration parameters in a system according to the present invention.

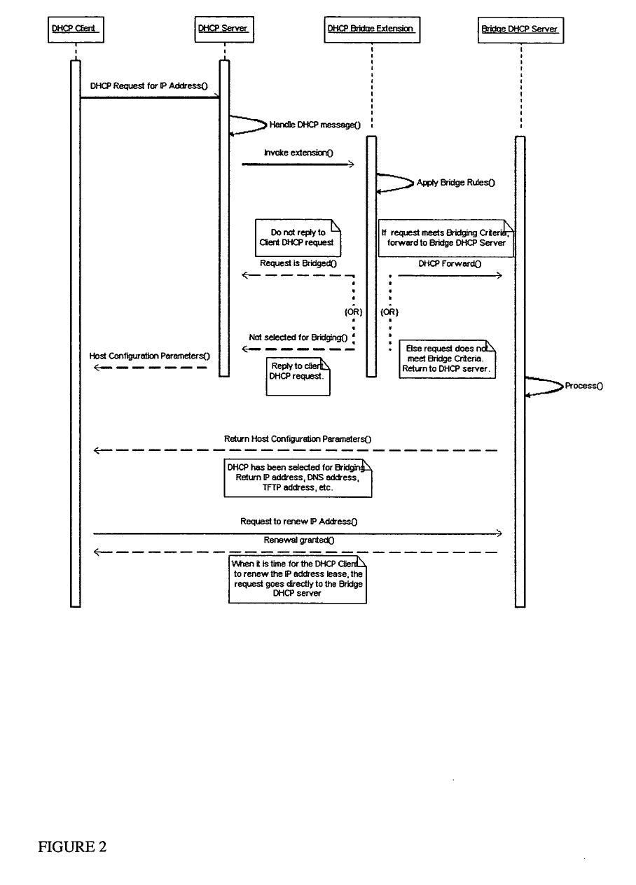

FIG. 3 shows components of the Intelligent Configuration Bridge according to a preferred embodiment of the present invention.

FIG. 4 shows an example of components and communication in the AUTO INSTALL II system in a system according to the present invention.

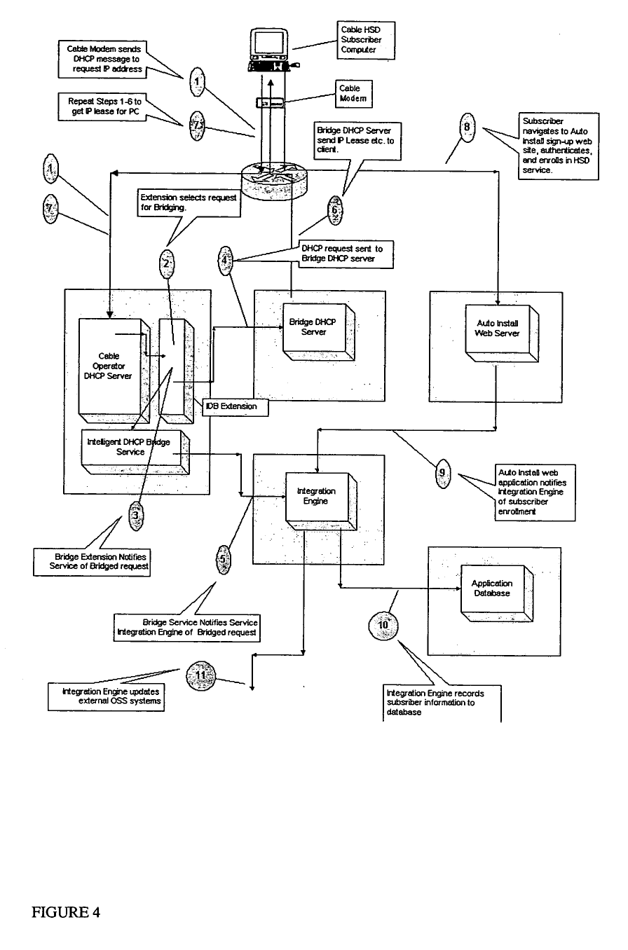

### DETAILED DESCRIPTION OF THE INVENTION

Among the objects of the invention is to provide an Intelligent Configuration Bridge (such as a DHCP Bridge) to extend the flexibility and functionality of a typical configuration server, such as for example a DHCP server. According to a preferred embodiment, the Intelligent Bridge works as a system extension to the existing (primary) DHCP server, or set of primary DHCP servers, allowing user selection based on hardware address and intelligent routing to other configuration devices, such as bridged DHCP servers. Selection can be based on variable and dynamic sets of selection criteria to route certain DHCP communications (and the associated users) to one or more external DHCP servers. The Intelligent Configuration Bridge provides a fine-grained and flexible control over the IP-related configuration parameters that are granted to the client devices in an IP network.

By directing selected DHCP traffic to another system, the Intelligent Configuration Bridge enables an operator to add additional systems of servers or applications “in parallel” with the operator's existing systems. The parallel systems can be focused on selected users or customer groups for a particular application. The parallel systems do not intrude upon or depend upon the operator's existing systems, and so they can be added more quickly and economically with little or no operational risk than would otherwise be possible.

The Intelligent Configuration Bridge can identify specific CPEs and end user terminal devices based on a unique identifier such as a physical ID (e.g. Media Access Control (MAC) address) and ensure that all IP traffic that transits from those devices is routed to a parallel physical network or application system. The specific routing information may then be provided to the Intelligent Configuration Bridge system by a flexible policy system that allows flexibility in selecting and routing the appropriate user to the new target Bridged system.

According to a preferred embodiment of the invention, the Intelligent Configuration Bridge is comprised of a system of software components or modules that work cooperatively with existing DHCP servers to extend the behavior of the typical DHCP request/response message sequence, and enable the addition of new services and products to clients of an IP network.

DHCP Message Processing and Criteria

According to a preferred embodiment, an Intelligent Configuration Bridge can use standard APIs to attach to the DHCP server and to examine DHCP request messages as they are processed by the DHCP server. In this preferred embodiment, an Intelligent Configuration Bridge integrates its message handling software routines with those of the DHCP server.

During the processing of the request from a DHCP client for an IP address (and additional configuration information), the DHCP server may examine the message and apply simple rules to the values of various message fields, such as chaddr (client hardware address), giaddr (relay agent IP address), and numbered options (optional parameter fields.) (For details on the DHCP message, see RFC 2131, by R. Droms). These rules may determine the specific content of the DHCP response, which supplies the client with host configuration parameters, including IP address for the client, IP address of a DNS server, IP address of a TFTP server, name of a device configuration bootfile (in the case of a cable modem), and other parameters. (See RFC 2131, by R. Droms, Appendix A, for additional host configuration parameters.)

The Intelligent Configuration Bridge extends the capabilities of the DHCP Server by applying an additional set of rules to the processing of each DHCP message. These rules compare values of the DHCP message to certain configurable and dynamic “bridging criteria,” in order to determine when to route a DHCP request.

Bridging and Bridging Criteria

Bridging a subscriber node configuration request, such as a DHCP request sent from a subscriber node may include selecting a DHCP request message based on rules, current message values, state values retained from previous messages, and bridging criteria, and routing the request to another Bridge DHCP server. The Bridge DHCP server may then send a response to the DHCP client, providing host configuration parameters (including client IP address, etc., as described previously.)

The second DHCP server may be a component of the Intelligent Configuration Bridge system. This server manages certain aspects of IP network connectivity for the DHCP client, in effect “capturing” that client for purposes of controlling network and application access, directing the client to specific web hosts that provide required or optional services, tracking the client's web usage, and so forth. According to a preferred embodiment, the Intelligent Configuration Bridge-managed aspects of IP connectivity that make this possible include the following:

IP address selection. IP addresses with special network routing characteristics can be assigned to the client. IP lease policies, such as expiration interval, can be controlled by the Bridge DHCP server, and when the client's DHCP process sends an IP lease renewal request, it comes to the Bridge DHCP server (not the original DHCP server.)

DNS server selection. DNS servers can be assigned to the client, in order to control the resolution of DNS host names and to direct a client's URL requests to specific web servers, which host Bridge-enabled applications. A DNS server used in this manner is a component of the Intelligent Configuration Bridge system.

TFTP server selection. For DHCP clients such as DOCSIS cable modems, which need to download configuration information from a TFTP server, the Bridge DHCP server provides the IP address of a TFTP server that hosts custom configuration files. A TFTP server used in this manner is a component of the Intelligent Configuration Bridge system.

Custom configuration files. For DHCP client devices such as DOCSIS cable modems, which require an additional configuration file or “bootfile,” custom files can be provided. Such files can control properties of the devices, including upstream and downstream data flow speeds.

Bridge Implementation and Location

In a preferred embodiment, the Bridge Extension (sometimes referred to as Bridge Extension Module) is implemented as a software component that interacts directly with a configuration server, such as a DHCP Server. Thus, it may reside on a DHCP server or its equivalent, and is designed to be a lightweight routine that does not impact the performance or functionality of the DHCP Server with which it collaborates. The Bridge Extension quickly determines whether a message is a candidate for bridging; if it is not, the Bridge Extension returns control to the DHCP Server, which resumes normal processing flow for the message.

If a message is selected for bridging, the Bridge Extension notifies the DHCP Server of this, the message is forwarded to a Bridged Configuration Server, such as a Bridge DHCP Server, and the original DHCP Server does not need to do any further processing. For a message that is bridged, the original DHCP Server could in fact do less processing than it would do for a non-bridged message.

According to a preferred embodiment, the Bridge Service (sometimes referred to as Bridge Service Module) is a program that may be run separately from the Bridge Extension, and interacts with it through Inter-Process Communication. The Bridge Service notifies the Bridge Extension of information needed to make bridging decisions. For example, it may provide the Bridge Extension with the chaddr or MAC address of a device, such as for example a cable modem, a DSL modem, a wireless modem, or a satellite modem of a subscriber node connected via a network to the configuration server, in effect telling the Extension to bridge any DHCP request from that device. The Bridge Service also receives information from the Bridge Extension that may be used to notify other systems, or to write logging information for operational purposes. By using the Bridge Service in this way, the Bridge Extension can delegate non real-time processing tasks, and run with little overhead.

The Bridge DHCP Server, in a preferred embodiment, is a software component that receives the bridged DHCP requests. The original DHCP Server and the Extension forward messages to the Bridge DHCP Server. Note that the Bridge DHCP Server does not have to be provided as part of the same implementation package as the Bridge Extension and Bridge Service. While it may be provided as part of a packaged product along with these other Bridge components, it may also be provided separately. An example of this configuration is a scenario in which a vendor supplies the Bridge Extension and Bridge Service to an operator, and the operator uses its own DHCP server configured as the Bridge Server.

Intelligent Configuration Bridge Components

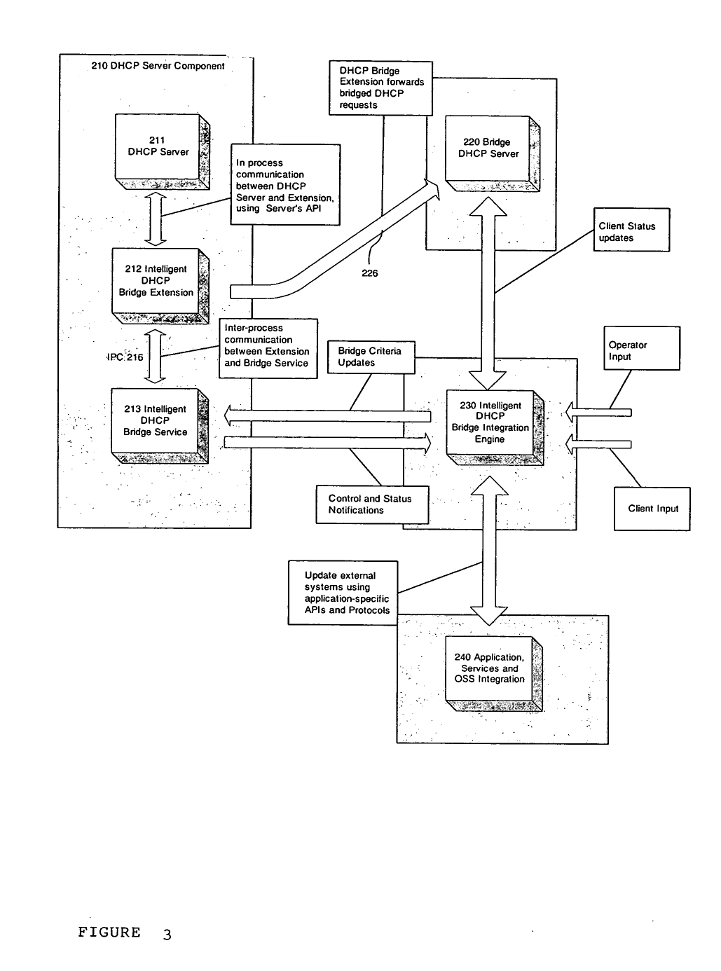

Individual software components of an Intelligent Configuration Bridge according to a preferred embodiment of the present invention are identified in FIG. 3. It will be understood that other configurations of the components are possible, this being a preferred embodiment.

DHCP Server Component 210 includes a DHCP Server 211 which is logically connected or associated with the following:

Intelligent DHCP Bridge Extension 212. The Intelligent DHCP Bridge Extension 212 can be designed leveraging the DHCP Server's extensibility APIs, and may be run on the same machine and optionally in the same process as the DHCP Server. It participates in the DHCP Server's evaluation and processing of DHCP requests, and makes determinations on when to bridge a request.

Intelligent DHCP Bridge Service 213. This component may be run on the same server machine as the DHCP Server 211 and the Intelligent DHCP Bridge Extension 212, and it communicates with the Intelligent DHCP Bridge Extension 212 using Inter-Process Communication (IPC) 216. Intelligent DHCP Bridge Service 213 also communicates with the Intelligent DHCP Integration Engine 230, using network protocols, to receive and to send updates concerning bridging criteria and values, such as chaddr (device MAC address), of devices that are candidates for bridging.

Bridge DHCP Server 220. The Bridge DHCP Server may be run on a separate server machine. It receives bridged DHCP requests across network link 226, and provides IP addresses and host configuration values to DHCP clients. This Bridge DHCP Server 220 may also be associated with a DNS server for resolving host names for the client, and a TFTP server, for providing access to configuration files.

Next Generation Broadband's Intelligent DHCP Bridge Integration Engine (NICLE) 230. The Integration Engine coordinates communication between other components of the system. It may accept input from client and operator interfaces, evaluate the input and update the Intelligent DHCP Bridge Service 213 with bridging information. It can also communicate with external systems, using network protocols and defined APIs to provision, de-provision, modify, or update services and applications for DHCP clients.

Parallel Systems Technology

According to a preferred embodiment, the Intelligent Bridge enables two or more DHCP servers to work together to permit a provider of IP network connectivity, services, and content to assign, offer, and enable different types and levels of service to different IP clients. Clients can be selected for assignment or enablement of services according to a flexible, fine-grained set of criteria. The Intelligent Bridge can provision these criteria dynamically, with a level of granularity ranging from individual clients to various groupings of clients. This criteria-based selection process goes beyond the capabilities of an ordinary DHCP server.

Use of the Intelligent Configuration Bridge can give a service provider greater control of IP services options than the operator would otherwise have. Since the DHCP client's IP access is bridged to a separate DHCP system, the system can control the client's network access for application-specific purposes, and point the client to new applications and services. These applications can be developed and tested as “Parallel Systems” apart from the service provider's current production systems. Then they can be physically deployed and “connected” to the service provider's network, via the Bridge.

Because the Parallel System is, according to a preferred embodiment, coupled to the service provider's system only through the Bridge, it has minimal impact on the design and operation of existing systems. It can use the same front-end network elements, and if required, it can be “turned off” at any time, without any impact on the existing systems. The system can be easily and rapidly deployed in an unmodified front-end network.

Illustrative Embodiment: AUTO INSTALL II

The AUTO INSTALL II system is an application developed by the inventors and is intended for use by, but not limited to, Cable HSD Operators. It is available from the assignee of the present application: NEXT GENERATION BROADBAND, 1025 Thomas Jefferson Street, Wash., D.C., 20007, www.ngb.biz. It leverages the Intelligent Configuration Bridging system to enable a subscriber to enroll for High Speed Data services online. At a high level, the AUTO INSTALL II system identifies that a new customer/modem has connected to the network; connects the subscriber though a cable modem and the IP network to an AUTO INSTALL platform running in parallel to the existing IP systems; directs the customer to a specialized service activation portal; collects the customer information and automatically collects the CPE MAC address information; saves the subscriber information and passes this information and cable modem ID and properties to the operator's backend systems; and returns the authorized user to the operator's existing IP operating system.

AUTO INSTALL II uses the Intelligent Bridge system, as described in the main section of this document. An illustrative example of the operation of such a system, for purposes of explanation, and not by way of limitation, is provided, as follows:

1. The subscriber connects a newly installed modem, such as a cable modem, to a data processor and to the network, such as via a cable outlet.

2. When the cable modem boots up, it broadcasts a DHCP message in order to get an IP address and additional configuration information.

3. The operator's DHCP server examines the chaddr (MAC address) in the DHCP message, and determines by checking its own data that the modem is not provisioned.

4. The Intelligent DHCP Bridge Extension examines the message, and sees that the DHCP server has identified it as unprovisioned; it determines that the cable modem meets the bridging criteria, and redirects the DHCP message to another server, for example, the Bridge DHCP server.

5. The Bridge DHCP server sends the cable modem an IP address, TFTP server address, bootfile name from its own scope and configuration.

6. The subscriber's PC, or CPE, which is behind the cable modem, sends a DHCP message requesting an IP address.

(The operator's DHCP server may or may not perform any criteria processing on the CPE DHCP message.)

7. The Intelligent DHCP Bridge Extension examines the message, sees that the message is from a CPE that is associated with an unprovisioned cable modem, determines that this meets the bridging criteria, and redirects the DHCP message to the Bridge DHCP server.

8. The Bridge DHCP Server sends the CPE an IP address, and DNS server IP address.

9. The DNS server address sent to the CPE resolves any URL requests from the CPE's web browser to the website of the AUTO INSTALL II service activation application.

10. The subscriber then enters required information in the AUTO INSTALL II service activation portal; and all necessary information, including authentication fields and cable modem physical address (MAC address), discovered automatically by AUTO INSTALL II, is sent by the service activation application to an Integration Engine.

11. The NICLE 230 updates the database maintained by the AUTO INSTALL II application, and sends all information across a network interface to the Operator's backend systems.

12. When the subscriber reboots his PC and cable modem, these devices are now detected by the Operator's DHCP server as provisioned. The subscriber then receives host configuration values from DHCP that will allow him the network and application services that he enrolled for.

The AUTO INSTALL II system, as shown in an illustrative embodiment in FIG. 3, is a system designed to integrate with and enhance the capabilities of an existing high speed data service provider's ISP provisioning infrastructure.

The AUTO INSTALL II system may be comprised of hardware, software and networking components. This system may be self contained, but is designed to integrate with all leading billing and provisioning systems as well as leading email and ISP infrastructure technology.

Examples of CPE in this AUTO INSTALL II illustrative embodiment and throughout this Application may include a terminal such as a personal computer, data processor or network-enabled IP device that is connected to the local area network or USB port side of the cable modem. Such a terminal may include a hand-held device or PDA or other data processor logically connectable, directly or indirectly, to a network node or modem, including a cable modem. Further, the terms “modem” and “cable modem” as used in this AUTO INSTALL II illustrative embodiment and throughout this Application, may include any network node to which a terminal or CPE can be connected, through which a network server compatible with the present invention may be connected.

Intelligent Configuration Bridge and AUTO INSTALL II

Under normal operating conditions, the IP address and various supporting files are served from the current (existing) DHCP and TFTP servers.

When the cable modem is plugged in and powered up, the modem typically performs an internal system test and establish its presence on the network. This is first done by the cable modem establishing a connection with the CMTS in accordance to well defined DOCSIS specifications.

In the next step, the cable modem requests an IP address and configuration information. This process is managed by the CMTS and DHCP server. If the modem is registered, the existing (primary) DHCP server will provide the modem its IP address, IP configuration settings and cable modem config file. If the modem is not provisioned or registered, then the task of providing these settings is transferred to the AUTO INSTALL II system. Furthermore, the CPE must receive IP address and IP settings also from the AUTO INSTALL II system. Under normal conditions the CPE IP address is served from a separate DHCP server.

The CPE Address request requires that the existing (primary) DHCP server check its associated database. The AUTO INSTALL II system is designed such that a database is part of the AUTO INSTALL II system. When a cable modem is being provisioned by the AUTO INSTALL II system, the MAC address for the cable modem is added to the AUTO INSTALL II database. When the CPE requests an IP address, the Intelligent Configuration Bridge will check the address request and cull out the MAC address of the cable modem. The MAC address will then be checked against an AUTO INSTALL II database.

The DNS setting points to a DNS server that is part of the AUTO INSTALL II system. For purposes of illustration, this DNS server is configured such that it spoofs all domain name addresses except for the self registration website. Subsequently, whatever website the subscriber requests will point to the Welcome Page of the AUTO INSTALL II self registration website. The Welcome page is the first page of the install/registration portal.

Service Activation

As a default configuration, the AUTO INSTALL II Service Activation process may be configured to: Activate the Subscriber account based on the plan selected in the initial order; assign User Name and password; provision ISP service and self management features; and complete the activation process.

AUTO INSTALL II is designed to enable the subscriber to select his own user name and password. As part of the Service Activation process and after the order has been submitted, the billing system or 3^{rd} party business system accepts the initial order and the AUTO INSTALL II system serves the subscriber a screen for selecting user name. The source for selecting user name can be either by a user name database or backend system. The AUTO INSTALL II system is designed such that customer facing application is logically separated from the communication with the backend system. In other words, the self registration portal is logically separate from the backend logic that manages the dialogue with abackend system and other customer business support applications. The customer through a graphical interface may modify the procedure and process for retrieving user names and passwords. As a default, the basic system may assume that user names and passwords are set through an interactive dialogue with the backend system after the initial service order has been accepted.

Service Provisioning and Activation

The AUTO INSTALL II System can be configured to instruct a backend system to complete the process. After the backend system has provisioned the service and confirmed that it has completed its work, the AUTO INSTALL II system notifies the subscriber that service has been provisioned. The AUTO INSTALL II system as a final step in the process presents the subscriber with a webpage that includes, for example, the transaction number; subscriber registration information; date and time; service package selected; and user name and password.

Software Architecture

According to a preferred embodiment of the AUTO INSTALL II system, the AUTO INSTALL II system is comprised of several software components. The software architecture may be divided into three major component groups. These components groups are described below.

### Web Servers, Template and AUTO INSTALL II Package Application

The web server, templates and AUTO INSTALL II Package control the interaction of the AUTO INSTALL II with the subscriber. The Web Server is multi-purpose. This system is used by the subscriber to access the AUTO INSTALL II application, the Admin Panel, and the NGB Integration Control Engine (NICLE).

### DHCP, DNS and LDAP

The Intelligent Bridge Service, Bridge Extension and associated database may reside on the existing (primary) DHCP server . . . AUTO INSTALL II also has its own additional DHCP, DNS, TOD and TFTP servers to provide this functionality to modems (users) routed to the parallel AUTO INSTALL II System.

### Admin Panel

The Admin Panel provides a secure web interface for the system administrator to: configure the AUTO INSTALL II System based on available options; manage user names and passwords; manage, retrieve and export system logs; produce management reports on the system's activity.

SafeHouse System

Next Generation Broadband's SafeHouse system is an application developed by the inventors and is intended for use by network operators. It leverages an Intelligent Bridge system to enable an operator to exercise dynamic control over a subscriber's access to broadband network resources and applications. The operator can select from its own menu of reasons for denying access. These reasons may include, for example, the following: the user has not paid a bill; the user has exceeded his usage quota; the user's system is infected with a computer virus; or, the user has exhibited unacceptable behavior, such as sending spam or abusive email.

Once an operator has identified the subscriber to restrict, the operator may enter the hardware address of the subscriber's modem into the SafeHouse System. The SafeHouse system provides an Operator Interface tool that allows the operator to: add a subscriber to SafeHouse; view any subscribers in SafeHouse, by location, by date, by reason; or remove a particular subscriber.

According to a preferred embodiment of the SafeHouse System, the main components may include:

1. An Operator Interface tool.

2. An Intelligent Bridge system (as described in the main part of this document).

3. An Integration Engine, which connects an Operator Interface tool to one or many Bridging Systems. There may be multiple Bridging Systems for an operator with a distributed network.

4. A Database, which stores information on SafeHouse subscribers, Intelligent Configuration Bridge configurations, and other system data.

5. Web applications that can be accessed by subscribers, for managing actions involving resolution of the SafeHouse status.

According to a preferred embodiment, after a subscriber's modem is entered into the system, the SafeHouse system will: determine the network location of the user; enter the user's modem hardware address into a database used by the Intelligent DHCP Bridge Extension; send an SNMP message to reset the modem; when the modem resets, the Intelligent DHCP Bridge Extension detects that the modem is selected for bridging, and a DHCP message is sent to the Bridge DHCP server.

The Bridge DHCP server assigns the modem an IP address and configuration file that restricts the access granted to the modem. When the CPE device associated with the isolated modem sends a message to renew its IP address, the Intelligent DHCP Bridge Extension detects that the modem for the CPE is isolated, and the DHCP message is bridged. The Bridge DHCP server now assigns the CPE a restricted IP address and a DNS server address that points all requests from the CPE to a web site controlled by the SafeHouse system.

The SafeHouse web site offers the user a range of actions that can be selected to remedy the SafeHouse condition. (For example, the website, may give a non-paying user the opportunity to enter credit card information in order to pay the balance of his account.)

According to a preferred embodiment, when the operator uses the SafeHouse system to remove a user from isolation, the system determines the network location of the subscriber; removes the subscriber's modem hardware address from the database used by the Intelligent DHCP Bridge Extension; sends an SNMP message to reset the modem; when the modem resets, the Intelligent DHCP Bridge Extension no longer selects the modem's DHCP message for bridging. The modem can now receive a regular IP address from the operator's DHCP server. The subscriber can now resume normal use of network resources and services.

Small and Medium Size Business Solution

The Small and Medium Size Business (SME) solution is an application of the Intelligent Bridge to provision specialized IP services to a subset of business users across a common IP platform. Residential and business users have different needs requiring separate ISP services such as email, content, applications and network management systems, and often these applications for business users may reside on separate physical networks or in separate data centers.

As a result, at the time of provisioning a business customer's CPE, the subscriber is designated to be set up in a SME user class which can later be selected by the Intelligent Bridge system. When this device requests an IP address from the main DHCP server, the Intelligent Bridge detects it and bridges to the Bridge DHCP server. As described earlier, the bridging decision is made by the Intelligent Bridge which recognizes a CPE and its associated terminal equipment that belongs to a specific user class such as business customer. The Intelligent Bridge also updates a SME database with the MAC address and IP address of the CPE and the status of the CPE such that when the terminal requests an IP address, the Intelligent Bridge can recognize the terminal equipment being associated with that IP address and then forward the DHCP REQUEST to the Bridge DHCP server.

The result is that after the CPE and its associated terminal equipment receive an IP address and configuration information, all of its IP traffic is now routed to the SME system.

Bandwidth on Demand

In the Bandwidth on Demand system, the user has the option of purchasing increased speed of service (increased bandwidth) for a specific purpose or length of time. The CPE can be set through a configuration file which then enables a maximum and minimum bandwidth in terms of kilo bits per second (KBPS) over an access network. The bandwidth and quality of service can be set for both upstream and downstream paths.

When a customer requests additional bandwidth (through a web portal application), the Bandwidth on Demand system resets the CPE configuration so that it can receive the proper bandwidth and quality of service. To achieve this, the given CPE must be temporarily provided a new IP address and configuration file by the Bridge DHCP server. Subsequently, the Bandwidth on Demand System will change the user class of that CPE associated with the user's MAC address. When the CPE requests an IP address from the DHCP it is routed to the Bandwidth on Demand System, where it receives a new IP address and configuration files.

The Bandwidth on Demand System may be configured to have its own DHCP server and applications. As with other embodiments, the Intelligent Bridge may be installed on the primary data center's DHCP server. The Intelligent Bridge forwards the DHCP REQUEST packet to the Bridge DHCP server and stops the primary DHCP server from processing the request. The Intelligent Bridge also updates a Bandwidth on Demand database dedicated to the Intelligent Bridge with the MAC address and IP address of the CPE and the status of CPE.

In addition, the Intelligent Bridge may also update a Bandwidth on Demand database with the IP address and the status of the CPE such that when the terminal requests an IP address, the Intelligent Bridge can also recognize the CPE being associated with that IP address and then forwards the DHCP REQUEST to a Bridge DHCP server. Subsequently, the terminal can receive its IP information from the Bridge DHCP server.

At this point, the CPE uses the new bandwidth settings. The Bandwidth on Demand application permits the user to use the new bandwidth settings for a defined period of time only. When that time is up, the Bandwidth on Demand system resets the CPE's user class back to its original setting. This is done by updating a database associated with the primary DHCP Server. The CPE is reset, so that it requests a new IP address. The primary DHCP server provides the CPE a new IP address and resets its configuration to its standard bandwidth settings.

Pre Paid System

According to one embodiment of the invention, a Pre-Paid System provides the service provider with a unique way of offering pre-paid services across the service provider's existing platforms without significant changes to their current systems. Services may be based on one of the following: on a time period, hours usage, or volumetric (KBPS) usage. Using the Intelligent Bridge , the Pre-Paid System allows the operator to install this functionality quickly into its network as a parallel or adjunct system.

On installation, the customer choosing this service may be forwarded to a special Pre-Paid portal and presented with sign up options regarding type of service and is set up automatically on this basis. At the end of the usage term the customer is routed back to the Pre-Paid portal to refill or cancel or suspend the service.

According to a preferred embodiment, the Pre-Paid System may be activated as follows: The Pre-Paid customer connects to the network; The Intelligent Bridge identifies Pre Paid customer and routes that customer to a Pre Paid portal; the customer completes activation on-line and purchases service. This process also normally involves the provision of credit card information for billing. The Pre-Paid system configures a customer's CPE in pre-paid class and offers IP leases allowing the customer to operate on the network until the time period or usage basis has expired.

The Pre-Paid service may also be renewed. For example, according to a preferred embodiment, when the time limit or usage base is reached, the Pre-Paid system can initiate a request to the Intelligent Bridge to bridge the user to the Pre-Paid system. The PrePaid system may also provide notification in advance that the subscriber is close to their usage limit. The user may then be redirected to the Pre- Paid portal to refill, cancel or suspend service.

The Pre-Paid system may also provide the following additional features:

Extend current subscription. The user enters personal information and credit card or other payment information. If payment verification was successful, then a notification of subscription extension will be sent to user's email address.

Select new subscription level. The user enters personal information and payment information.

Discontinuation of service. If the user chooses not to extend or select new subscription, network services will be discontinued once usage limited reached. If a user decides to re-join the subscription after the usage limit has been reached, the Pre-Paid system will redirect the user to the Pre-Paid portal and proceed with the sign up process.

The Enterprise Network Application

The Intelligent Bridge System is also applicable in an enterprise network environment. Often in these types of networks, specific applications and departmental or sub-networks need to be restricted, only permitting authorized end devices, access.

The Intelligent Bridge can simplify overall management of distributed, networks by providing a centralized system that can determine which end device should access which network or system based on its physical address. With the Intelligent Bridge, an end device can be assigned to a separate physical network. As an example, the Intelligent Bridge can be configured to associate the MAC address of a particular device with a specific physical network. When the Intelligent Bridge, receives an IP address request, it identifies the MAC address and checks its database to determine which physical network, that end device belongs to and routes the device to the desired separate network.

The process is controlled by a separate Next Generation Broadband Policy Server that lets a network manager appropriately configure the Intelligent Bridge to perform these necessary tasks.

Secured Networks

The technology of using Intelligent Bridge may also be applied to secured networks in a similar manner to the above example for enterprise networks. In secured networks, compartmentalization and device authentication are critical. The Intelligent Bridge enables a secured network user to expand the capabilities of a DHCP server to segregate end devices into separate physical networks based on the device's physical (MAC) address.

The Intelligent Bridge simplifies overall management of distributed, but secure networks by providing a centralized system that can determine which end device should access which system. In the secured network situation, the nodes are typically distributed and often mobile. With the Intelligent Bridge, an end device can be assigned directly to a specific physical network. When the Intelligent Bridge, receives an IP address request, it identifies the individual device MAC address and checks its database to determine which physical network, that end device belongs to and forwards the device and IP address request to the required destination network. In addition, to determining the appropriate network for the device, the Intelligent Bridge database may also include location and security data required to successfully reach the destination physical network so that an IP address request can be successfully forwarded.

Computer Systems

One embodiment of this invention resides in a computer system. Here, the term “computer system” is to be understood to include at least a memory and a processor. In general, the memory will store, at one time or another, at least portions of an executable program code, and the processor will execute one or more of the instructions included in that executable program code. It will be appreciated that the term “executable program code” and the term “software” mean substantially the same thing for the purposes of this description. It is not necessary to the practice of this invention that the memory and the processor be physically located in the same place. That is to say, it is foreseen that the processor and the memory might be in different physical pieces of equipment or even in geographically distinct locations.

Computer Program Products

The above-identified invention may be embodied in a computer program product, as will now be explained. Software that enables the computer system to perform the operations described may be supplied on any one of a variety of media. Furthermore, the actual implementation of the approach and operations of the invention are actually statements written in a programming language. Such programming language statements, when executed by a computer, cause the computer to act in accordance with the particular content of the statements. Furthermore, the software that enables a computer system to act in accordance with the invention may be provided in any number of forms including, but not limited to, original source code, assembly code, object code, machine language, compressed or encrypted versions of the foregoing, and any and all equivalents.

One of skill in the art will appreciate that “media,” or “computer-readable media”, as used here, may include a diskette, a tape, a compact disc, an integrated circuit, a ROM, a CD, a cartridge, a remote transmission via a communications circuit, or any other similar medium useable by computers. For example, to supply software for enabling a computer system to operate in accordance with the invention, the supplier might provide a diskette or might transmit the software in some form via satellite transmission, via a direct telephone link, or via the Internet. Thus, the term, “computer readable medium” is intended to include all of the foregoing and any other medium by which software may be provided to a computer.

Although the enabling software might be “written on” a diskette, “stored in” an integrated circuit, or “carried over” a communications circuit, it will be appreciated that, for the purposes of this application, the computer usable medium will be referred to as “bearing” the software. Thus, the term “bearing” is intended to encompass the above and all equivalent ways in which software is associated with a computer usable medium.

For the sake of simplicity, therefore, the term “program product” is thus sometimes used to refer to a computer useable medium, as defined above, which bears in any form of software to enable a computer system to operate according to the above-identified invention. Thus, the invention is also embodied in a program product bearing software which enables a computer to perform according to the invention.

The previous description of preferred embodiments is provided to enable a person skilled in the art to make and use the present invention. It will be understood that whenever specific machines or components are described as being of a certain type or manufactured by a named manufacturer, other similar machines and components may be used, so long as the similar machines and components suitably perform the tasks in keeping with the spirit of the present invention.

Embodiments of the present invention overcome some disadvantages described above and other disadvantages. However not all embodiments of the present invention necessarily overcome the disadvantages described above or the other disadvantages.

Moreover, various modifications to these embodiments and combinations thereof, will be readily apparent to those skilled in the art, and the generic principles and specific examples defined herein may be applied to other embodiments without the use of inventive faculty. For example, some or all of the features of the different embodiments discussed above may be combined into a single embodiment. Conversely, some of the features of a single embodiment discussed above may be deleted from the embodiment. Therefore, the present invention is not intended to be limited to the embodiments described herein but is to be accorded the widest scope as defined by the limitations of the claims and equivalents thereof.

### Appendix

Glossary

The following glossary of some of the terms used is from “Internetworking with TCP/IP Principles, Protocols, and Architecture” Douglas Comer, 4 edition, Prentice Hall, 2000 ISBN 0-13-018380-6. A definition of a term in any of the following glossaries merely provides a point of departure for further study and in no way limits the scope of the disclosure or the claims herein. In particular, certain terms contained in any of the following glossaries may be used slightly differently or with a different and/or broader range of meaning in the claims.

Address resolution: Conversion of a protocol address into a corresponding physical address (e.g. conversion of an IP address in an Ethernet address). Depending on the underlying network, resolution may require broadcasting on a location network.

API: Application Program Interface—The specification of the operations an application program must invoke to communicate over a network.

ARP: Address Resolution Protocol—The TCP/IP protocol used to dynamically bind a high-level IP address to a low-level physical hardware address. ARP is used across a single physical network and is limited to networks that support hardware broadcast.

Backbone Network: Any network that forms the central interconnect for an internet.

Bridge: A computer or application that connects two or more networks and forwards packets among them.

Client-Server: The model of interaction in a distributed system in which a program at on side sends a request to a program at another site and awaits a response. The requesting program is a called a client; the program satisfying the request is called the server.

DHCP: Dynamic Host Configuration Protocol—A protocol that a host uses to obtain all necessary configuration information including an IP address. DHCP is a popular with ISPs because it allows a host to obtain a temporary IP address.

DNS: Domain Name System—The on-line distributed database system used to map human-readable machine names into IP addresses. DNS servers throughout the connected Internet implement a hierarchical namespace that allows sites freedom in assigning machine names and addresses. DNS also supports separate mappings between mail destinations and IP addresses.

DSL: Digital Subscriber Line—A set of technologies used to provide high-speed data service over the copper wires that connect between telephone offices, local residences or businesses.

End-to-end: Characteristics of any mechanism that operates only on the original source and final destination. Applications and transport protocols like TCP are classified as end-to-end.

FTP: File transfer protocol—The TCP/IP standard, high-level protocol for transferring files from one machine to another. FTP uses TPC.

Hardware address: The low-level addresses used by physical networks. Synonyms include physical address and MAC address. Each type of network hardware has its own addressing scheme. For example, Ethernet address is 48 bits.

IANA: Internet Assigned Number Authority—IANA was originally responsible for assigning IP addresses and the constraints used in TCP/IP protocols. Replaced by ICANN in 1999.

ICANN: Internet Corporation for Assigned Names and Numbers—The organization that took over the IANA duties.

IETF: Internet Engineering Task Force—A group of people under the LAB who work on the design and engineering of TCP/IP and the global Internet.

IAB: Internet Architecture Board—The group of people who set policy and direction for TCP/IP and the global Internet.

internet: Physically, a collection of packet switching networks interconnect by routers along with TCP/1IP protocols that allow them to function logically as a single, large virtual network.

Internet: The collection of networks and routers that spans over 200 countries and uses TCP/IP protocols to form a single, cooperative virtual network.

IP: Internet Protocol—The TCP/IP standard protocol than defines the IP datagram as the unit of information passed across an internet and provides the basis for connection-less, best effort packet delivery service. The entire protocol suite is often referred to as TCP/IP because TCP and IP are the two fundamental protocols.

IP address: A 32-bit address assigned to each host that participates in a TCP/IP internet. IP addresses are the abstraction of physical hardware address just as the internet is an abstraction of physical networks.

MAC: Media Access Control—A general reference to the low-level hardware protocols used to access a particular network.

Proxy: Any device or system that acts in place of another.

RFC: Request for Comments—The name of a series of notes that contain surveys, measurements, ideas, techniques and observations as well as proposed and accepted TCP/IP protocols standards.

Server: A running program that supplies service to clients over a network.

TFTP: Trivial File Transfer Protocol—The TCP/IP standard protocol for file transfer with minimal capability and minimal overhead. TFTP depends only on the unreliable, connectionless datagram delivery service (UDP).

UDP: User Datagram Protocol=The protocol that allows an application program on one machine to send a datagram to an application program on another. UDP uses the Internet Protocol (IP) to deliver datagrams.

The following glossary is from Source CableLabs web set Glossary. Please note that the definitions provided here in no way limit the scope of the terms of the claims.

Access Network: The part of the carrier network that touches the customer's premises. The Access Network is also referred to as the local drop, local loop, or last mile.

Cable Modem: A modulator-demodulator at subscriber locations intended for use in conveying data communications on a cable television system. Cable Modems offer a very high speed connection to the Internet, up to 30 Megabits per second (several hundred times the speed of a 56 Kbps modem). Technically speaking, though, a cable modem is not a modem at all, but a broadband network bridge.

Cable Network: Refers to the cable television plant that would typically be used for data over cable services. Such plants generally employ a downstream path in the range of 54 MHz on the low end to a high end in the 440 to 750 MHz range and an upstream path in the range of 5 to 42 MHz. Customers share a common communication path for upstream and a separate common path for downstream (i.e., effectively a pair of unidirectional buses).

Cable System: Facility that provides cable service in a given geographic area, comprised of one or more headends.

CMTS: Located at the cable television system headend or distribution hub, a CMTS provides complementary functionality to the cable modems to enable data connectivity to a wide-area network.

CPE: Customer Premise Equipment—Equipment at the end user's premises; MAY be provided by the end user or the service provider.

DOCSIS: The Data-Over-Cable Service Interface Specification. DOCSIS defines requirements for cable modems and cable modem termination systems that enable broadband internet access.

DSLAM: A DSLAM is an xDSL line-interface device located in a telephone company Central Office. One side of a DSLAM connects to customer premises network interface devices (NIDs) over the local loop. The other side interfaces with the PSTN and a wide area (Frame Relay or ATM) network system.

Ethernet: The most popular LAN technology in use today. The IEEE standard 802.3 defines the rules for configuring an Ethernet network. It is a 10 Mbps, 100 Mbps, or 1000 Mbps CSMA/CD baseband network that runs over thin coax, thick coax, twisted pair or fiber optic cable.

Gateway: A function or server that acts as a point of interconnection between two different networks.

The following glossary is from Internet Engineering Task Force, Request for Comment 1531 Dynamic Host Configuration Protocol. Please note that the definitions provided here in no way limit the scope of the terms of the claims.

DHCP client: A DHCP client is an Internet host using DHCP to obtain configuration parameters such as a network address.

DHCP server: A DHCP server is an Internet host that returns configuration parameters to DHCP clients.

BOOTP relay agent: BOOTP relay agent is an Internet host or router that passes DHCP messages between DHCP clients and DHCP servers. DHCP is designed to use the same relay agent behavior as specified in the BOOTP protocol specification.

Binding: A binding is a collection of configuration parameters, including at least an IP address, associated with or “bound to” a DHCP client. Bindings are managed by DHCP servers.

The following is a list of documents that may be of use to understand in greater detail various aspects of the background of the present invention: ; Dynamic Host Configuration Protocol (RFC 1531); Clarifications and Extensions for the Bootstrap Protocol (RFC 1532); Interoperation Between DHCP and BOOTP (RFC 1534); DHCP Options and BOOTP Vendor Extensions (RFC 1533); DHCP Options and BOOTP Vendor Extensions (RFC 1533); Clarifications and Extensions for the Bootstrap Protocol (RFC 1542); Dynamic Host Configuration Protocol (RFC 1541); Dynamic Host Configuration Protocol (RFC 2131); DHCP Options and BOOTP Vendor Extensions (RFC 2132); DHCP Options for Novell Directory Services (RFC 2241); Netware/IP Domain Name and Information (RFC 2242); DHCP Option for The Open Group's User Authentication Protocol (RFC 2485); Procedure for Defining New DHCP Options (RFC 2489); DHCP Option to Disable Stateless Auto-Configuration in IPv4 Clients (RFC 2563); DHCP Options for Service Location Protocol (RFC 2610); Procedure for Defining New DHCP Options and Message Types (RFC 2939); The Name Service Search Option for DHCP (RFC 2937); The User Class Option for DHCP (RFC 3004); The Subnet Selection Option for DHCP (RFC 3011); DHCP Relay Agent Information Option (RFC 3046); DHC load balancing algorithm (RFC 3074); Authentication for DHCP Messages (RFC 3118); DHCP reconfigure extension (RFC 3203); The DOCSIS Device Class DHCP Relay Agent Information Sub-option (RFC 3256); Encoding Long Options in DHCPv4 (RFC 3396); The Classless Static Route Option for Dynamic Host Configuration Protocol (DHCP) version 4 (RFC 3442); Dynamic Host Configuration Protocol (DHCP) Option for CableLabs Client Configuration (RFC 3495); Link Selection sub-option for the Relay Agent Information Option for DHCPv4 (RFC 3527); Dynamic Host Configuration Protocol for IPv6 (DHCPv6) (RFC 3315); PacketCable Security Ticket Control Sub-option for the DHCP CableLabs Client Configuration (CCC) Option (RFC 3594).

What is claimed is:

1. In a system having a terminal controlled by a user; a cable modem (CM) attached to the terminal; an existing Internet Protocol (IP) based service delivery platform connected to the CM, and a first CM dynamic host configuration protocol (CM-DHCP) server, separate and external from the existing system, including a second DHCP server, a method for adding at least one supplemental service to the existing IP service platform, comprising:
receiving a request from the CM for an IP Address;
determining at the first DHCP whether the CM meets certain criteria;
if the CM does meet the criteria, forwarding the request to a second DHCP; and
in response to the forwarded request, providing the IP Address and CM configuration settings from the second DHCP back to the CM.

2. The method of claim 1 wherein the system further comprises a provisioning server the method further comprising:
managing CM activities through the provisioning server until the CM is properly synchronized with the existing system.

3. The method of claim 1 further comprising:
delivering supplemental services associated with the CM to the existing system via the provisioning server.

4. The method of claim 1 wherein the supplemental service is added without interaction from any Operator personnel.

5. The method of claim 2 wherein the managing comprises synchronizing the existing system and a billing system associated with the existing system.

6. The method of claim 5 wherein the synchronizing the existing system further comprises:
configuring the CM.

7. The method of claim 5 wherein the synchronizing the existing system further comprises:
configuring existing system services.

8. The method of claim 5 wherein the synchronizing the billing system further comprises establishing a billing relationship between the existing system and the consumer.

9. The method of claim 1 further comprising:
transferring system control of cable modem activities to an ISP infrastructure external to the existing system.

10. A configuration server for receiving and processing a subscriber node address request, said configuration server comprising:
a bridge service module and a bridge extension module;
said bridge service module configured to provide a predetermined bridging criterion to said bridge extension module;
said bridge extension module configured to make a bridging determination based on the bridging criterion and the subscriber node address request; and
said bridge extension module further configured to provide a bridging message based on the subscriber node address request, when a result of the bridging determination indicates that the bridging message is to be provided.

11. The configuration server of claim 10, wherein the configuration server is a DHCP server, a subscriber node comprises at least one of a cable modem, a DSL modem, a wireless modem, and a satellite modem attached to a user terminal, and the address request is a request for an IP address received via a network.

12. The configuration server of claim 11, wherein the predetermined criterion is based on whether the modem associated with the subscriber node is recognized as new to the network.

13. The configuration server of claim 10, wherein the predetermined criterion is based on at least one of: a type of user associated with the subscriber node, a size of a business user entity associated with the subscriber node, a payment method utilized by a user associated with the subscriber node, a pre-paid status associated with the subscriber node, a bandwidth requirement associated with the subscriber node, a bandwidth subscription associated with the subscriber node, a subscription payment record associated with the subscriber node, a usage history associated with the subscriber node, a usage quota associated with the subscriber node, a user behavior associated with the subscriber node, and a network security indication associated with the subscriber node.

14. A processor-readable medium incorporating a program of instructions to be executed by a configuration server, the program configured to process a subscriber node address request received, the program comprising:
a bridge service module and a bridge extension module;
said bridge service module configured to provide a predetermined bridging criterion to said bridge extension module;
said bridge extension module configured to make a bridging determination based on the predetermined bridging criterion and the subscriber node address request; and
said bridge extension module further configured to provide a bridging message based on the subscriber node address request, when a result of the bridging determination indicates that the bridging message is to be provided.

15. The processor-readable medium of claim 14, wherein the configuration server is a DHCP server, a subscriber node comprises at least one of a cable modem, a DSL modem, a wireless modem, and a satellite modem attached to a user terminal, and the address request is a request for an IP address received via a network.

16. The processor-readable medium of claim 15, wherein the predetermined criterion is based on whether the modem associated with the subscriber node is recognized as new to the network.

17. The processor-readable medium of claim 14, wherein the predetermined criterion is based on at least one of: a type of user associated with the subscriber node, a size of a business user entity associated with the subscriber node, a payment method utilized by a user associated with the subscriber node, a pre-paid status associated with the subscriber node, a bandwidth requirement associated with the subscriber node, a bandwidth subscription associated with the subscriber node, a subscription payment record associated with the subscriber node, a usage history associated with the subscriber node, a usage quota associated with the subscriber node, a user behavior associated with the subscriber node, and a network security indication associated with the subscriber node.

18. A configuration system, comprising:
a configuration server for receiving and processing a subscriber node address request; and
a bridged configuration server;
said configuration server comprising:
a bridge service module and a bridge extension module;
said bridge service module configured to provide a predetermined bridging criterion to said bridge extension module;
said bridge extension module configured to make a bridging determination based on the predetermined bridging criterion and the subscriber node address request; and
said bridge extension module further configured to provide to said bridged configuration server a bridging message based on the subscriber node address request, when a result of the bridging determination indicates that the bridging message is to be provided.

19. The configuration system of claim 18, wherein the configuration server is a DHCP server, a subscriber node comprises at least one of a cable modem, a DSL modem, a wireless modem, and a satellite modem attached to a user terminal, and the address request is a request for an IP address received via a network.

20. The configuration system of claim 18, wherein control of the processing of the subscriber node address request is transferred to the bridged configuration server when the bridging message is provided by the configuration server.

21. The configuration system of claim 18, wherein the bridged configuration server is part of a separate physical network.

22. The configuration system of claim 18, wherein said bridge extension module is configured to receive a second predetermined bridging criterion from said bridge service module and to provide to a second bridged configuration server the bridging message, when the result of the bridging determination based on the second predetermined bridging criterion and the subscriber node address request indicates that the bridging message is to be provided to the second bridged configuration server.

23. The configuration system of claim 18, wherein the bridged configuration server is configured to provide at least one of an IP address and configuration information to the subscriber node based on the bridging message.

24. The configuration system of claim 19, wherein the predetermined criterion is based on whether the modem associated with the subscriber node is recognized as new to the network.

25. The configuration system of claim 18, wherein the predetermined criterion is based on at least one of: a type of user associated with the subscriber node, a size of a business user entity associated with the subscriber node, a payment method utilized by a user associated with the subscriber node, a pre-paid status associated with the subscriber node, a bandwidth requirement associated with the subscriber node, a bandwidth subscription associated with the subscriber node, a subscription payment record associated with the subscriber node, a usage history associated with the subscriber node, a usage quota associated with the subscriber node, a user behavior associated with the subscriber node, and a network security indication associated with the subscriber node.

26. A configuration system for receiving and processing a subscriber node address request, said configuration system comprising:
bridge service means and bridge extension means;
said bridge service means for providing a predetermined bridging criterion to said bridge extension means;
said bridge extension means for making a bridging determination based on the bridging criterion and the subscriber node address request; and
said bridge extension means for providing a bridging message based on the subscriber node address request, when a result of the bridging determination indicates that the bridging message is to be provided.

27. The configuration system of claim 26, wherein the subscriber node address request is processed according to DHCP, the subscriber node sending the subscriber node address request comprises at least one of a cable modem, a DSL modem, a satellite modem and a wireless modem attached to a user terminal, and the address request is a request for an IP address received via a network.

28. The configuration system of claim 27, wherein the predetermined criterion is based on whether the modem associated with the subscriber node is recognized as new to the network.

29. The configuration system of claim 26, wherein the predetermined criterion is based on at least one of: a type of user associated with the subscriber node, a size of a business user entity associated with the subscriber node, a payment method utilized by a user associated with the subscriber node, a pre-paid status associated with the subscriber node, a bandwidth requirement associated with the subscriber node, a bandwidth subscription associated with the subscriber node, a subscription payment record associated with the subscriber node, a usage history associated with the subscriber node, a usage quota associated with the subscriber node, a user behavior associated with the subscriber node, and a network security indication associated with the subscriber node.

30. The configuration system of claim 26, further comprising bridged configuration means, wherein control of the processing of the subscriber node address request is transferred to the bridged configuration means when the bridging message is provided by said bridge extension means to said bridged configuration means.
